(19) United States
(12) Patent Application Publication
(10) Pub. No.: US 2008/0116321 A1
(43) Pub. Date: May 22, 2008

(54) Lift spoiler for parked aircraft

(76) Inventor: Timmy Tuinder, Naguabo, PR (US)

Correspondence Address: ALFRED J MANGELS, 4729 CORNELL ROAD, CINCINNATI, OH, 452412433, US

(21) Appl. No.: 11/602,592

(22) Filed: Nov. 22, 2006

(51) Int. Cl. B64C 3/58

(52) U.S. Cl. 244/198

(57) ABSTRACT

A lift spoiler for use on the wings of parked aircraft to reduce lift forces produces by the aircraft wings and that are produced during storms and high wind speed conditions. The lift spoiler includes a generally rectangular spoiler panel that is supported relative to the wing upper surface by a pair of holders. The holders include suction-cup-type attachments for securely attaching the lift spoiler relative to the wing upper surface to deflect airflow over the wing surface and thereby reduce the lift effect of the airflow that acts on the wing to otherwise lift the aircraft during high wind speed conditions and cause possible damage to the aircraft while it is parked.

### BACKGROUND OF THE INVENTION

1. Field of the Invention

The present invention relates to a lift spoiler for reducing the lift forces that are produced on the wings of parked aircraft during storms or as a result of high wind speed conditions. More particularly, the present invention relates to a portable lift spoiler in the form of an elongated panel that can be easily and quickly installed on a wing of a parked aircraft, without cumbersome cords or straps that wrap around the wing and without anchor members that engage leading and trailing edges of the wing, and that also can be quickly and easily removed when desired prior to flight.

2. Description of the Related Art

Every year, and around the world, many aircraft parked outdoors experience severe damage during storms or when exposed to high winds. The damage is often the result of the effects of high wind speeds that generate lift forces when the winds pass over the wings of the parked aircraft. Unless it is restrained in some effective way, a parked aircraft can even be lifted off the ground during very high wind speed conditions that approach aircraft takeoff speeds.

The preferred method of protecting aircraft when high wind conditions are forecast is to park the aircraft indoors, out of the weather, in a hanger. However, hanger space is very limited in most airports around the world, and consequently many aircraft must remain parked outdoors, where they are exposed to the elements.

Another method of avoiding wind damage problems is to fly the aircraft away from the projected storm area, to a safe location, which is only possible when sufficient advance warning of an impending storm is given. In that regard, many types of high wind speed conditions, such as thunderstorms, are very unpredictable, and they often appear without adequate warning, leaving the aircraft parked outdoors exposed to high wind conditions. Additionally, some parked aircraft might not be in a flyable condition for various mechanical reasons. Therefore, flying such aircraft to another location is not an option, even if adequate warning of a storm is given.

A very common way that aircraft parked outdoors are protected against high winds and storms and are secured in position is by the use of tiedowns. In that approach, various portions of the aircraft are connected by cables, or the like, to anchoring devices that are firmly installed in the ground. Although tiedowns provide some protection in moderate wind speed conditions, they have sometimes been proven to be ineffective during very high wind speed conditions—tiedowns often break or separate in high wind speed conditions. In some very high wind speed conditions, such as hurricanes or other tropical storms accompanied by high winds, the anchoring devices can even be pulled from the ground, rendering the tiedown approach useless. A further problem with the tiedown approach is that is has been shown sometimes to result in structural damage to the wings or to other portions of the aircraft, because of the high tension forces that arise in the tiedown cable under high wind speed conditions, and that are transferred to the cable connection points on the wings and on other portions of the aircraft structure.

Although there have been various forms of lift spoiling arrangements proposed in the past, they were generally cumbersome and awkward to install and remove. They frequently involved the use of cables or straps to hold a spoiler in position, and sometimes included gripping elements that gripped the leading and trailing edges of a wing. There is thus a need for an improved, portable, light weight, and easily installed and removed lift spoiler in order to disrupt the destructive lift forces that are generated on parked aircraft during high wind conditions, and thereby to minimize damage to such parked aircraft.

### SUMMARY OF THE INVENTION

Briefly stated, in accordance with one aspect of the present invention, a lift spoiler is provided for removable attachment to an aircraft wing surface. The lift spoiler includes an elongated, substantially rectangular lift spoiler panel. A pair of suction cup holders are each engageable with respective longitudinally spaced ends of the spoiler panel for supporting the spoiler panel adjacent a surface of an aircraft wing. The spoiler panel has a longitudinal axis that extends substantially longitudinally along the wing surface and has a transverse axis adapted to extend substantially perpendicular to the wing surface. When attached to an aircraft wing by the suction cup holders the spoiler panel defines an upwardly and longitudinally extending deflector, to deflect and divert airflow over the wing surface to minimize lift forces that would otherwise act on the wing by virtue of the airflow over the wing surface.

### BRIEF DESCRIPTION OF THE DRAWINGS

The structure, operation, and advantages of the present invention will become further apparent upon consideration of the following description, taken in conjunction with the accompanying drawings in which:

FIG. 1 is a front perspective view of a portion of an aircraft wing including an embodiment of a three-panel lift spoiler assembly and associated panel holders secured to the upper surface of the wing;

FIG. 2 is a perspective rear view of the wing and lift spoiler assembly shown in FIG. 1;

FIG. 3 is an enlarged, front perspective view of a single panel lift spoiler assembly showing the panel holders before activation of the holding arrangement that secures the lift spoiler to the wing upper surface;

FIG. 4 is a side view of a holder for a lift spoiler panel before it is activated;

FIG. 5 is a top view of the holder shown in FIG. 4;

FIG. 6 is a front elevational view of a single panel lift spoiler and associated holders showing in phantom the depth to which the panel is received in the holder;

FIG. 7 is a side elevational view, in cross section, of a lift spoiler panel holder showing the holder and components before activation of the holding arrangement;

FIG. 8 is a view similar to FIG. 7 showing the holder and components after activation of the holding arrangement; and

FIG. 9 is a fragmentary cross-sectional view of a suction cup pad and associated structure that forms part of the holding arrangement.

### DESCRIPTION OF THE PREFERRED EMBODIMENTS

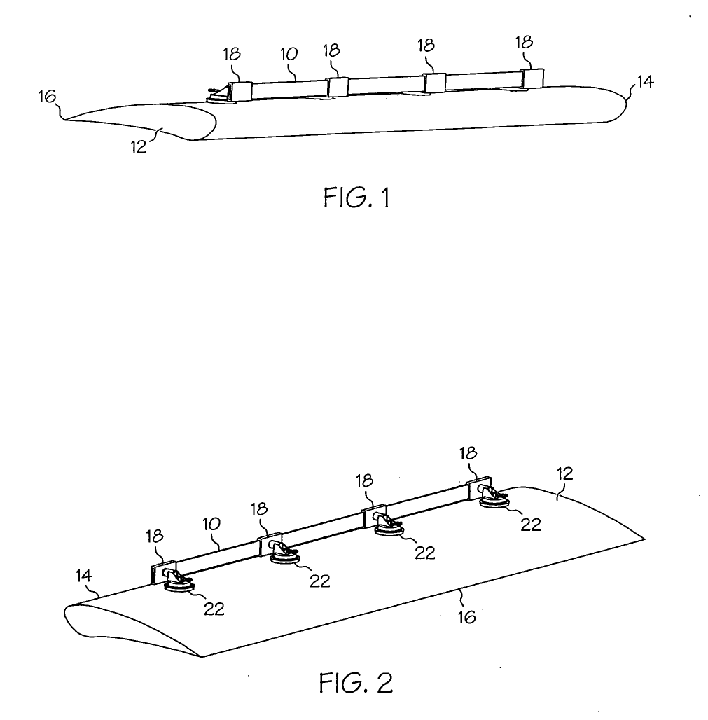

Referring now to the drawings, and particularly to FIGS. 1, 2, and 3 thereof, there is shown a lift spoiler panel 10 in operative position on an aircraft wing 12. Spoiler panel 10 is an elongated panel that extends in a longitudinal direction of wing 12, along the span direction of the wing, and is positioned between wing leading edge 14 and wing trailing edge 16. As shown in FIG. 1, spoiler panel 10 is disposed so that it is substantially parallel to and is spaced rearwardly from wing leading edge 14. The spacing of spoiler panel 10 from wing leading edge 14 for maximum lift-spoiling effect is generally dependent upon the cross-sectional or airfoil shape of the wing. Preferably, spoiler panel 10 is disposed adjacent the point on the wing upper surface that corresponds with the point of maximum camber, although it could also be somewhat forward or somewhat rearward of that point and still be effective for reducing the wing lift.

As shown, a spoiler assembly includes at least one spoiler panel 10 and associated spoiler panel holders 18. FIG. 1 shows a front perspective view of a spoiler assembly having three spoiler panels 10 that are supported by four longitudinally spaced holders 18. Spoiler panels 10 are rigid, rectangular elements and can be provided in any convenient length and width. For example, spoiler panels 10 can have a length dimension of about 2 to 3 ft., a width or height dimension of about 3 to 6 ins., and a thickness dimension of about ¼ to ½ in. Spoiler panels 10 can be a solid component, or they can be hollow for reduced weight. However, they must be sufficiently rigid to withstand the loading imposed by high wind speeds without significant deflection.

In terms of materials, spoiler panels 10 can be formed from a wide variety of materials, including plastics. A suitable spoiler panel material having the desired structural rigidity and light weight is a fiberglass reinforced injection molded plastic material, such as high-density polyethylene, polypropylene, and the like. One such panel material is available from Vertec Polymers Inc. of Houston, Tex. and is sold under the trademark PEEK. When that material is utilized in a spoiler panel having the dimensions given above, the panel weight is about 1.5 lbs.

FIG. 2 is a rear perspective view of the spoiler arrangement shown in FIG. 1. FIG. 2 shows more clearly the holder configuration for supporting spoiler panels 10, utilizing holders 18, which are suction-cup-type holders, and which are shown in the activated position, in which they are in firm engagement with the wing upper surface.

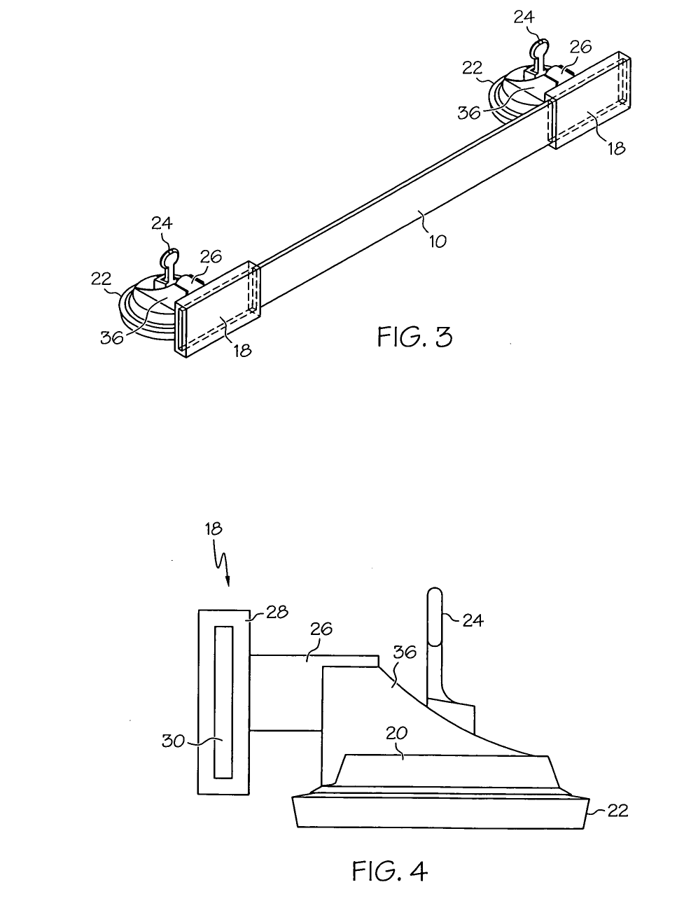

FIG. 3 is a front perspective view of a lift spoiler having only one spoiler panel 10, the longitudinal ends of which are supported by respective spaced panel holders 18. As they are shown in FIG. 3, holders 18 are in the inactivated position, merely resting on the wing, and not in firm engagement with the wing upper surface.

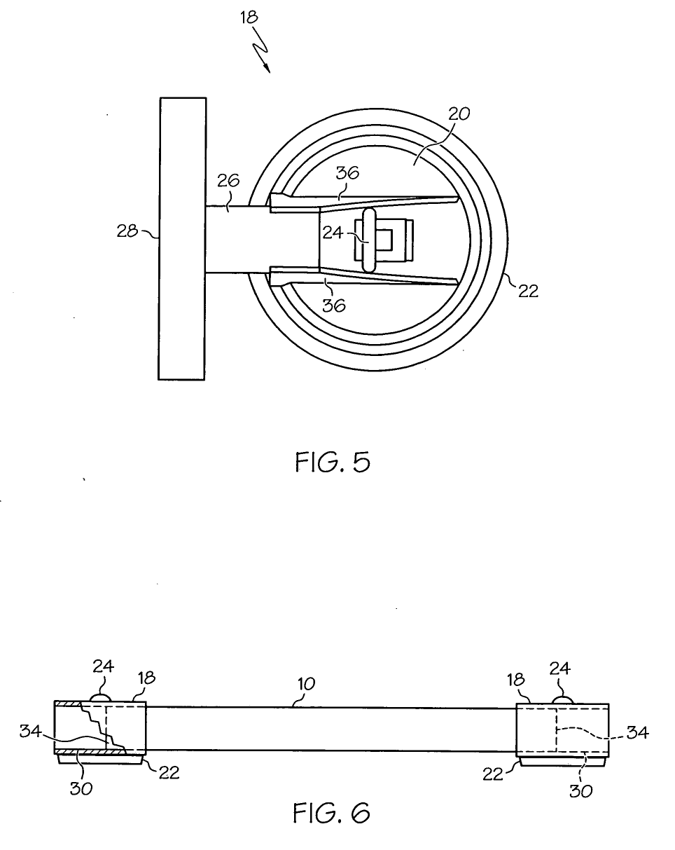

Holder 18 is shown in a side view in FIG. 4 and in a top view in FIG. 5. As shown, holder 18 includes a holder base or housing 20 that serves as a housing for receiving and holding a suction cup in the form of a rubber disc 22 for engagement with the wing upper surface. The suction cup disc 22 is activated by an operating lever 24, which is pivotably carried on housing 20. Operating lever 24 is shown in FIGS. 4 and 5 in the off or inactivated position, in which rubber disc 22 is flat and in which substantially its entire lower surface lies against the upper surface of the aircraft wing. A support arm 26 extends laterally from holder housing 20, in a direction substantially parallel to the wing surface or to a wing chord, and substantially perpendicular to wing leading edge 14. Support arm 26 can advantageously be in the form of a hollow or tubular element, to reduce the weight of holder 18. At its outermost end support arm 26 is attached to and supports a spoiler panel receiver 28 that includes at least one generally rectangular slot 30 for slidably receiving an end of a spoiler panel 10. Slot 30 extends substantially perpendicular to the longitudinal axis of support arm 26, and it can have a predetermined depth 32, as shown in FIG. 6, in which two opposed slots 30 are shown. Slot depth 32 can be of the order of about 2½ inches, and can be limited by an inner end wall 34. Alternatively, slot 30 can extend completely through spoiler panel receiver 28 to provide a through-opening to receive opposed ends of two adjacent, oppositely directed spoiler panels 10.

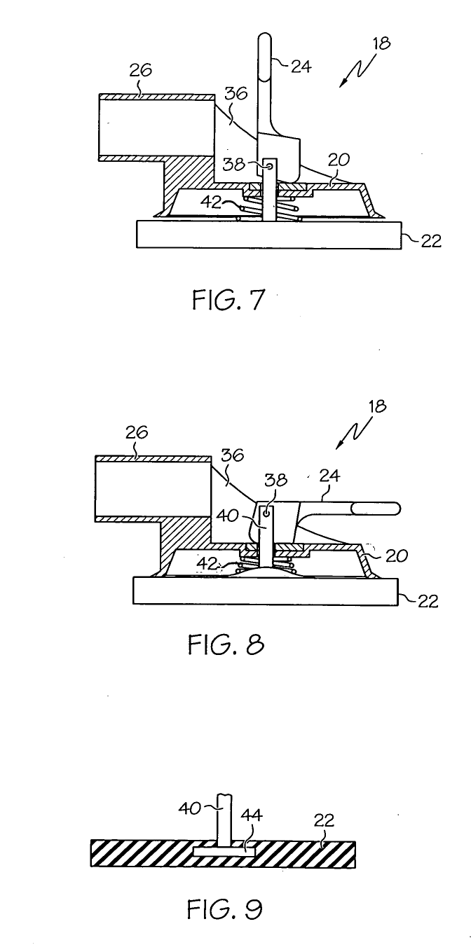

FIGS. 7 and 8 are cutaway views of holder 18, without a spoiler panel receiver 28, to show the internal structure of the holder and also the positioning within housing 20 of the actuation components of the suction cup attachment arrangement. As can be seen, housing 20 is a generally cup-shaped structure and is connected to hollow support arm 26 by a pair of spaced, parallel gussets 36, only one of which is visible in FIGS. 7 and 8. A pivot pin 38 is carried by and extends between gussets 36 to pivotably support operating lever 24 between the gussets. Extending into the interior of housing 20 and connected to pivot pin 38 is an actuator bar 40 that extends into rubber disc 22. A compression spring 42, which can be a helical coil spring or a spiral spring, as shown, extends between the inner surface of housing 20 and the upper surface of rubber disc 22 to bias the disc in a downward direction. FIG. 7 shows the suction cup arrangement with operating lever 24 in the vertical or upright position, in which rubber disc 22 is in its relaxed, flat condition, whereas FIG. 8 shows operating lever 24 in its horizontal or folded-over position, in which the inner or central portion of rubber disc 22 is deflected upwardly, in a distended, cupped or dished condition, to provide a vacuum that enables the rubber disc 22 of the suction cup arrangement to firmly engage the aircraft wing surface.

FIG. 9 is a cross-sectional view through rubber disc 22, showing the way by which actuator bar 40 engages and deflects the disc. The lowermost end of actuator bar 40 is attached to a rigid plate 44, which can be a metal plate and can be of any convenient form, such as rectangular, oval, circular, or the like. Plate 44 has an area that is of sufficient size so that when actuator bar 40 is drawn upwardly by the pivoting of operating lever 24, plate 44 carries the inner or central portion of rubber disc 22 upwardly. The lower peripheral edge of housing 20 holds an outer circumferential region of rubber disc 22 stationary. As a result of the induced deflection of the inner portion of rubber disc 22 away from the wing surface, a chamber is formed between the adjacent wing surface and the lowermost surface of rubber disc 22. The chamber is at an air pressure level that is lower than the ambient atmospheric pressure, which causes the rubber disc to firmly remain in contact with and to adhere to the wing surface by virtue of the pressure differential.

As will be appreciated, rubber 22 must be of such a form and have sufficient flexibility so that it readily deflects when operating lever 24 is turned from the position at which rubber disc 22 is relaxed, to the position at which it is centrally deflected or distended. In that regard, a rubber disc made from Caoutchouc natural rubber, having a thickness of about ¼ inch, and a durometer of about 50 has been found to operate satisfactorily. One suitable rubber material is available from Guangzhou Kedalong Hardware Tool Component Factory, of Guangzhou City, Guangdong Province, China, under the trademark KD, as catalog number BP1.

As will be readily apparent to those skilled in the art, the disclosed arrangement provides an effective aircraft wing lift spoiler for parked aircraft, along with a light weight attachment structure for quickly and effectively attaching the lift spoiler to an aircraft wing. The disclosed arrangement is fully self-contained, and no tools are required to attach the lift spoiler, nor are attachment cords, straps, or other similar attachment devices needed. The disclosed lift spoiler arrangement can be designed to withstand and to be fully operative and effective at wind speeds of up to about 200 mph. Moreover, the disclosed form of spoiler assembly has been shown to be effective to reduce by up to 77% the lift forces acting on an aircraft wing over the wing area at which the disclosed lift spoiler is installed.

Although particular embodiments of the present invention have been illustrated and described, it will be apparent to those skilled in the art that changes and modifications can be made without departing from the spirit of the present invention. Accordingly, it is intended to encompass within the appended claims all such changes and modifications that fall within the scope of the present invention.

What is claimed is:

1. A lift spoiler for removable attachment to an aircraft wing surface, said lift spoiler comprising:
a. an elongated, substantially rectangular, lift spoiler panel;
b. a pair of suction cup holders each engageable with respective longitudinally spaced ends of the spoiler panel for supporting the spoiler panel adjacent a surface of an aircraft wing, the spoiler panel having a longitudinal axis adapted to extend substantially longitudinally along the wing surface and having a transverse axis adapted to extend substantially perpendicular to the wing surface, wherein the spoiler panel defines an upwardly and longitudinally extending deflector to deflect and divert airflow over the wing surface to minimize lift forces that would otherwise act on the wing by virtue of the airflow over the wing surface.

2. A lift spoiler in accordance with claim 1, wherein the holders include a housing having a spoiler receiver for receiving a spoiler panel.

3. A lift spoiler in accordance with claim 2, wherein the spoiler receiver includes a slot corresponding in shape with a spoiler panel cross section for receiving and holding a respective end of the spoiler panel.

4. A lift spoiler in accordance with claim 2, wherein the spoiler receiver is supported from a support arm carried by the housing.

5. A lift spoiler in accordance with claim 2 wherein the holder includes a flexible disc and the housing includes a downwardly-facing peripheral rim in contact with an outer region of the disc.

6. A lift spoiler in accordance with claim 5, wherein the holder includes an operating lever pivotally carried by the holder for activating an actuator bar attached to the flexible disk for deflecting an inner region of the disc relative to the outer region to provide a downwardly-facing, cup-shaped chamber that defines a low air pressure chamber when the disc is in contact with a surface.

7. A lift spoiler in accordance with claim 1, wherein the lift spoiler is a solid member.

8. A lift spoiler in accordance with claim 1, wherein the lift spoiler is a hollow member.
